(19) United States
(12) Patent Application Publication
(10) Pub. No.: US 2005/0136709 A1
(43) Pub. Date: Jun. 23, 2005

(54) Docking station connector with differential signaling capability

(76) Inventor: Michael A. Link, Cornelius, OR (US)

Correspondence Address: BUCKLEY, MASCHOFF, TALWALKAR LLC, 5 ELM STREET, NEW CANAAN, CT, 06840, US

(21) Appl. No.: 10/739,692

(22) Filed: Dec. 18, 2003

(51) Int. Cl. H01R 12/00

(52) U.S. Cl. 439/79

(57) ABSTRACT

According to some embodiments, a docking station connector may include differential signaling capability.

### BACKGROUND

Many mobile and peripheral devices connect to desktop or other computing systems using a docking station. Docking stations typically have a connector that mates with a similar docking connector on the mobile or peripheral device. The docking station itself is often connected directly to a desktop computer, facilitating communications between the mobile or peripheral device and the desktop computer. Many mobile or peripheral devices however, support faster data rates, higher frequencies, or lower voltages than docking station connectors allow. The docking station connector may therefore impede mobile or peripheral device communication rate and/or integrity.

### BRIEF DESCRIPTION OF THE DRAWINGS

FIG. 1 is a block diagram of a system.

FIG. 2 is a block diagram of a docking station connector.

FIG. 3 is a block diagram of a docking station connector routing.

FIG. 4 is a flow diagram of a method according to some embodiments.

FIG. 5 is a block diagram of a docking station connector according to some embodiments.

FIG. 6 is a block diagram of a docking station connector routing according to some embodiments.

FIG. 7 is a block diagram of a system according to some embodiments.

### DETAILED DESCRIPTION

Some embodiments described herein are associated with a “docking station”. As used herein, the term “docking station” generally refers to any device, port, cable, connector, cradle, and/or interface that permits one or more portable, peripheral, mobile, and/or any other types of network devices to communicate with one or more other network devices. In some embodiments, a docking station may refer to a laptop docking station such as the EasiDock® 1000EV offered by Mobility Electronics™, Inc., or a docking cradle for a personal digital assistant (PDA) such as a universal serial bus (USB)/serial desktop cradle for Compaq® iPAQ® 3800, 3900, 5400, and 5500 series PDA devices. In some embodiments a docking station may refer to a connector, cradle, and/or other interface for peripheral devices such as printers, facsimile machines, scanners, and/or cameras.

In some embodiments a docking station may include one or more “docking connectors”. As used herein, the term “docking connector” may generally refer to any portion, component, port, and/or other device located within, attached to, and/or otherwise associated with a docking station that allows the docking station to be connected to a network device. In some embodiments a docking connector may include one or more pins and/or other protruding electrical contacts (a male connector) or one or more pin and/or electrical contact receptors, indentations, and/or holes (a female connector). As used herein the terms “docking connector” or “connector” may generally and interchangeably refer to male, female, and/or a combination of male and female connector types. In some embodiments, a docking connector may refer to a connector on and/or otherwise associated with a network device that may be designed to mate with a corresponding connector on and/or associated with a docking station.

In addition, some embodiments are associated with a “network device”. As used herein, the phrase “network device” may refer to any device that can communicate via a network. Examples of network devices include a Personal Computer (PC), a workstation, a server, a printer, a scanner, a facsimile machine, a copier, a PDA, a storage device (e.g., a disk drive), a hub, a router, a switch, and a communication device (e.g., a modem, a wireless phone, etc.). Network devices may comprise one or more network components. As used herein, the term “network component” may refer to a network device, or a component, piece, portion, or combination of network devices. Examples of network components may include a Static Random Access Memory (SRAM) device or module, a network processor, and a network communication path, connection, port, or cable.

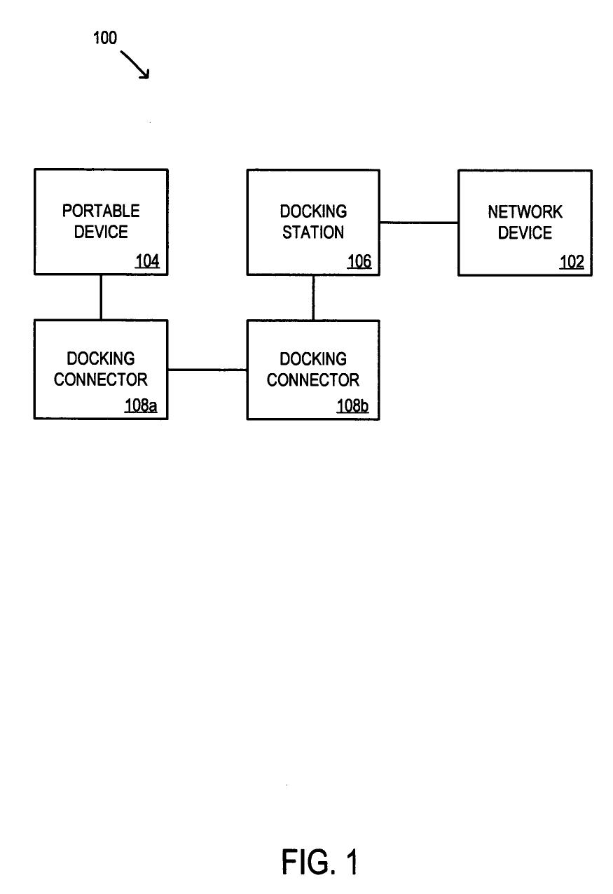

Referring first to FIG. 1, a block diagram of a system 100 for facilitating electronic communication between network devices is depicted for use in explanation, but not limitation, of described embodiments. Upon reading this disclosure, those skilled in the art will appreciate that different types, layouts, quantities, and configurations of systems may be used.

System 100 may comprise, for example, a network device 102 connected to a portable device 104 via a docking station 106 and docking connectors 108. The network device 102 may be or include a desktop, server, workstation, and/or other known or available computing device. Either and/or both of the network device 102 and the portable device 104 may be any type of network devices available, known, and/or described herein. Examples of the portable device 104 may include PDA devices, laptop and mobile computers, wireless telephones, and digital cameras.

The docking station 106 may be or include any type and/or configuration of device that enables the network device 102 to communicate with the portable device 104. Some docking stations 106 such as docking cradles for PDA devices may also provide physical support for a connecting device to facilitate mating of docking connectors 108. The docking connectors 108 may be, for example, one or both of a male and female pin connector for mating the docking station 106 with the portable device 104. In some configurations the docking connectors 108 may include components that are affixed separately to each of the docking station 106 and the portable device 104.

For example, the portable device 104 may include a docking connector 108a which may be a male pin connector such as a nine, fifteen, or twenty-five pin connector known in the art. The docking station 106 may include a corresponding docking connector 108b which may be a female pin connector, so that the two devices 104, 106 may be mated by joining the connectors 108. In such configurations the docking connectors 108 effectively comprise portions of both the portable device 104 and the docking station 106. Alternatively, the docking connectors 108 may be considered to include only one connector and/or device such as the connector 108a, 108b located on and/or attached to either one of the connecting devices 104, 106. In some embodiments, the docking connectors 108 may be or include a device that is separate and/or distinct from both the docking station 106 and the portable device 104.

By way of example, system 100 may include a network device 102 which may be a desktop PC having one or more ports such as a USB port. The docking station 106 may be, for example, a docking cradle for a handheld computing device, and may be connected to the USB port of the desktop PC 102 via a USB cable. The portable device 104 may be a PDA or other handheld device having a docking connector 108a adapted to mate with a corresponding docking connector 108b attached to the docking station 106. The PDA 104 may be placed in the docking cradle 106, for example, causing a mating of the connectors 108 and permitting the PDA 104 to interface with the desktop PC 102. Communications between the PDA 104 and the PC 102 may thus be transmitted through the docking connectors 108 (and the docking cradle 106) to allow the two devices 102, 104 to interact.

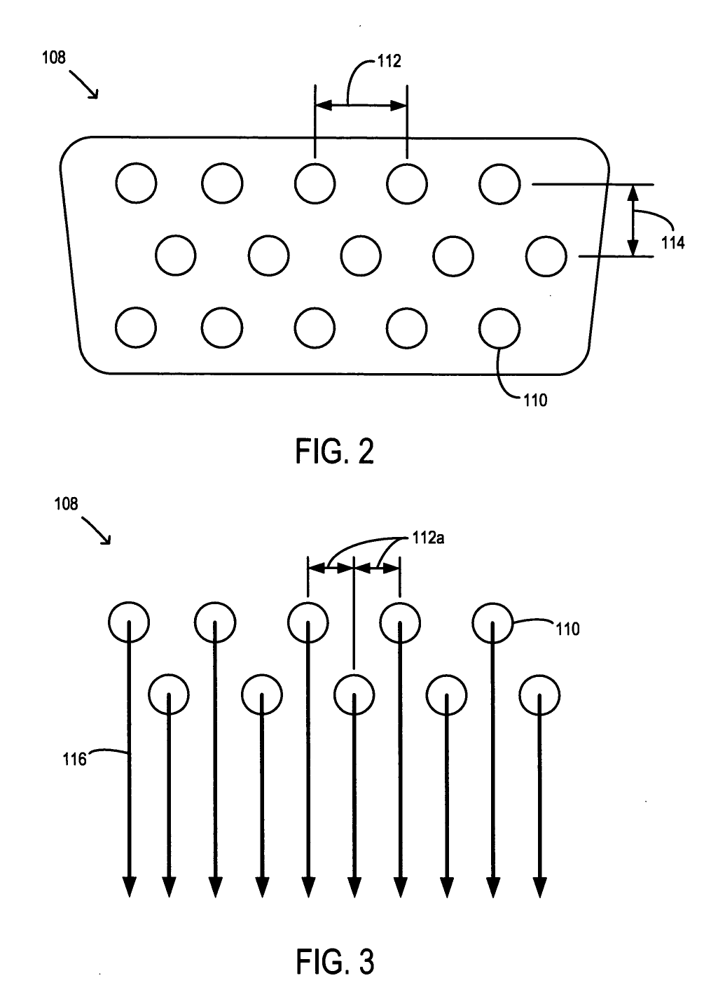

FIG. 2 shows an exemplary layout of the pins or other electrical contacts on a docking connector 108 that may be utilized, for example, in the system 100. The docking connector 108 shown in FIG. 2 is a typical fifteen-pin connector known in the art. Each electrical contact 110 may be or include a pin, pin receptacle, or any other electrical contact available, known, and/or described herein. The electrical contacts 110 of the docking connector 108 are arranged in a pattern that enhances the density and routing of the electrical connections. For example, the horizontal center-to-center spacing 112 between adjacent contacts 110 may be set at a value that permits the contacts 110 to be placed very close to each other (which will be at least in part dictated by the diameter or gauge of the contacts 110, the geometry of the contacts 110, and other considerations known to those skilled in the art). Similarly, the vertical center-to-center spacing 114 between vertically adjacent contacts and between rows of contacts may also be set or chosen to increase the number of contacts 110 that may be situated on a docking connector 108 with a given size and/or shape.

In FIG. 3 an exemplary routing layout for a docking connector 108 is shown. For ease of depiction only two rows of evenly spaced and uniformly offset rows of electrical contacts 110 are shown. Each electrical contact 110 is shown connected to an electrical or other communications path or trace 116. The electrical paths 116 may, for example, connect a printed circuit board (PCB) or other electronic device or component to the electrical contacts 110 of the docking connector 108. In configurations where the electrical contacts 110 are evenly spaced and the rows of contacts uniformly offset from each other (as shown), the spacing 112a between electrical paths 116 may be equivalent to one half of the horizontal spacing 112 maintained between electrical contacts. An advantage of such a configuration is that the electrical paths 116 may be spaced for high density, allowing a large number of electrical paths 116 to be routed through the docking connector 108 or other electrical conduit such as a port or cable.

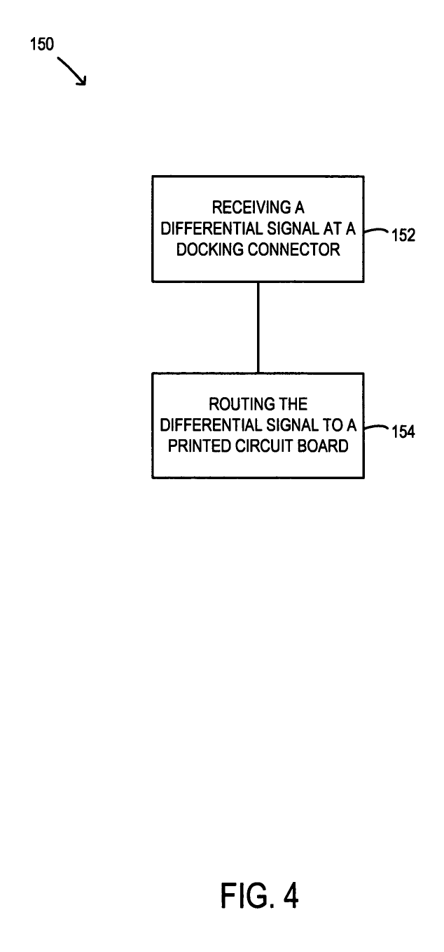

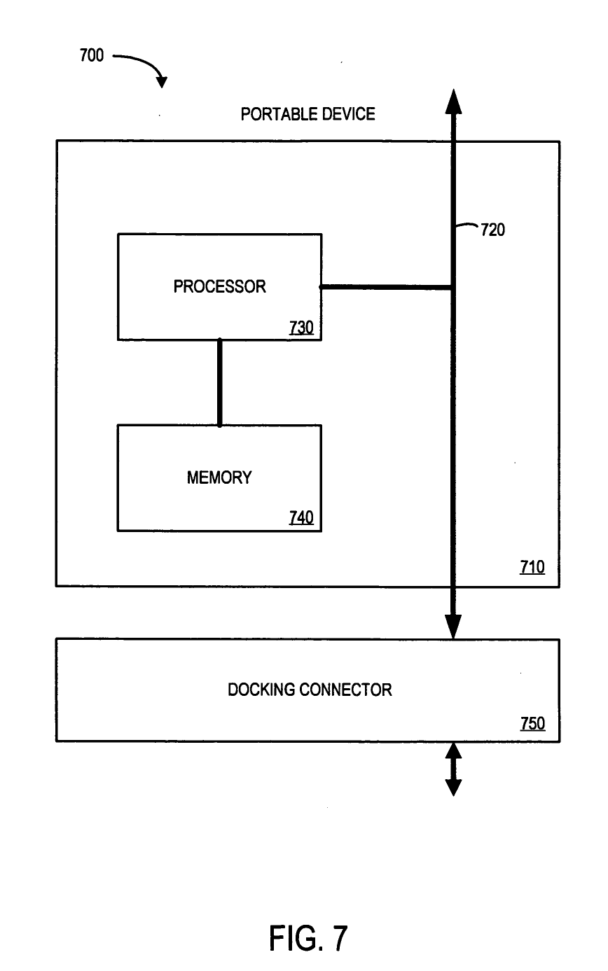

Turning now to FIG. 4, a flow diagram of a method 150 in accordance with some embodiments is shown. The method of FIG. 4 may be associated with and/or performed by, for example, the system 700 (or one or more of the system components) described in conjunction with FIG. 7 herein. The flow diagrams described herein do not necessarily imply a fixed order to the actions, and embodiments may be performed in any order that is practicable. Note that any of the methods described herein may be performed by hardware, software (including microcode), firmware, or any combination thereof. For example, a storage medium may store thereon instructions that when executed by a machine result in performance according to any of the embodiments described herein.

In some embodiments (such as shown in FIG. 4), the method 150 may begin by receiving a differential signal at a docking connector, at 152. For example, a portable network device such as a PDA or laptop computer may have the capability to communicate and/or transmit data using differential signals. Such a device may be connected to a docking station to interface with another device such as a PC, and may transmit data and/or other information via differential signals to and/or through the docking connector. The docking connector may reside within and/or be attached to either the device sending the differential signal or the device receiving the signal, and/or the docking connector may include portions, parts, and/or components of each device as described herein in conjunction with FIG. 1. In some embodiments, other signals instead of, in addition to, and/or in conjunction with the differential signal may be received by the docking connector. Other signals may include, for example, other higher speed, higher frequency, and/or lower voltage signals. In some embodiments, the docking connector may receive at least one differential signal as well as other non-differential signals.

According to some embodiments, at least one of the pins and/or other electrical contacts on the docking connector may be arranged to allow for the reception of the differential signal. For example, differential signals are often transmitted along paths of substantially equal impedance and length. The two paths are also typically separated by a small distance that is maintained uniformly throughout the lengths of the paths. Thus, according to some embodiments, the contacts for a differential signal pair may be placed at a determined distance from each other to promote the successful reception of a differential signal (which may include, for example, maintaining the integrity of the differential signal). The differential signal pair contacts may also, according to some embodiments, be spaced at one or more determined distances from other signal contacts to prevent interference with the reception and/or quality of the differential signal.

In some embodiments, the arrangement of the docking connector contacts may permit Peripheral Component Interconnect (PCI) Express such as that defined by the PCI Express Base Specification 1.0a, 1394 such as that defined by IEEE 1394B-2002 Standard for Higer Performance Serial-Bus Amendment 2 (2002), USB 2.0 such as that defined by the USB Revision 2.0 Specification (revised Dec. 21, 2000), and/or other signals to be transmitted through the docking connector. According to some embodiments, the layout, spacing, arrangement, and/or any other electrical contact parameter associated with the docking connector may be determined based on the specifications of the signal and/or signals desired for transmission through the docking connector. For example, one or more pins or other contacts of the docking connector may be arranged in accordance with the transmission requirements defined in one or more of the specifications for the signals listed above.

At 154, the differential signal may be routed to a PCB and/or other device. For example, the docking connector may include electrical paths or traces leading from the connector contacts to a PCB inside of a PDA and/or other docked or docking device. In some embodiments, in order to maintain the integrity of the differential signal pair, the electrical paths may be routed to substantially maintain a determined separation and/or impedance, and/or may be routed so that each path is substantially the same length. Any number of factors including, but not limited to, spacing, gauging, routing, and/or shielding may be manipulated and/or determined, for example, to arrange at least one contact of a docking connector so that the docking connector may approximate an optimal transmission line for a differential signal. In some embodiments, a software simulation program and/or other design tool may be utilized to determine an appropriate arrangement of one or more pins of a docking connector to allow transmission of differential signals through the connector.

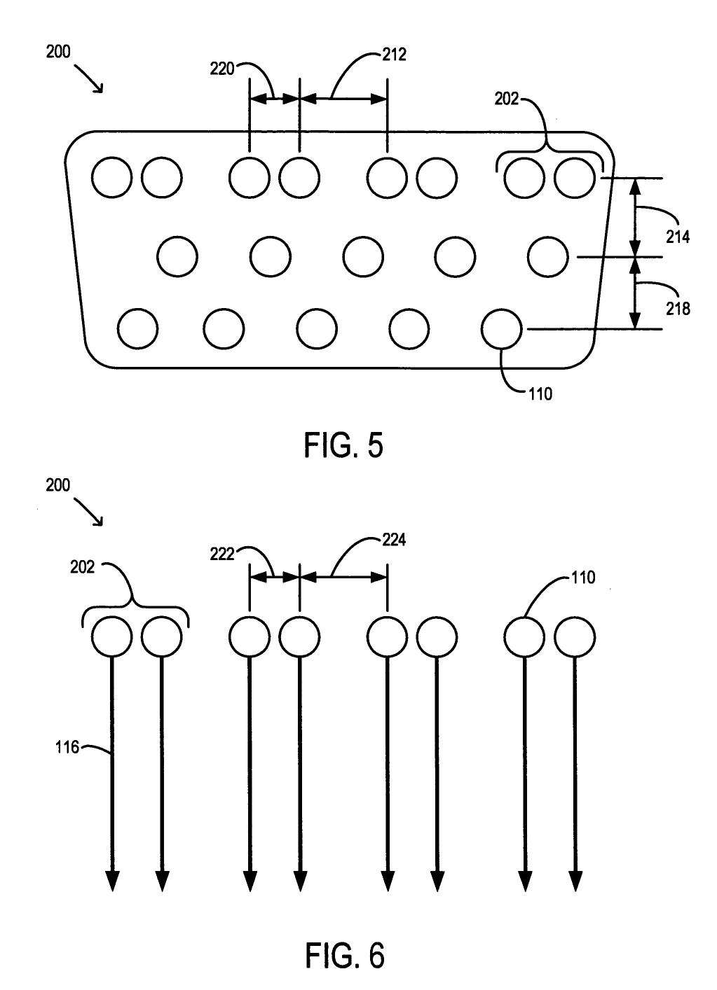

FIG. 5 shows an exemplary layout of the pins or other electrical contacts on a docking connector 200 that may be utilized, for example, in the system 700 or by various network devices and/or docking stations conducting and/or involved in conducting method 150. The docking connector 200 may, according to some embodiments, contain one or more pairs of electrical contacts 202 arranged for reception and/or transmission of a differential signal. As shown in FIG. 5, an entire row of electrical contacts 110 may be arranged in differential contact pairs 202. According to some embodiments, a single differential contact pair 202 may be arranged on the docking connector 200. For example, a single additional pin receptacle may be added to a standard fifteen-pin female docking connector to create a differential contact pair 202. In some embodiments, standard fifteen-pin male devices may still be able to connect to such a docking connector 200, while the differential contact pair 202 may also permit differential signaling devices to utilize the same docking connector 200.

According to some embodiments, any practicable number of differential contact pairs 202 may be arranged on the docking connector 200 and they may be arranged in any pattern and/or manner that may be desirable and/or useful (i.e., the contacts 110 do not necessarily need to be arranged in uniform and/or symmetrical order or in the manner shown in FIG. 5). The arrangement of the contacts 110 may, according to some embodiments, be determined using a software program such as a simulation program for differential signal routing and/or design. For example, a simulation program may be used to determine a desirable differential contact pair spacing 212. The pair spacing 212 may be any distance that is sufficient, given the amount of path insulation, the gauge of the contacts, and other pertinent information known to those skilled in the art, to isolate individual differential contact pairs 202 from each other. Other signal contacts 110 may similarly be maintained at an appropriate distance 214 from differential contact pairs 202.

In some embodiments where multiple rows of contacts 110 are arranged on the docking connector 200, the distance between various contact rows 218 may also be determined. In some embodiments the distance 218 may represent the separation between non-differential signal contact rows (as shown in FIG. 5). In some configurations the separation distance 218 may be determined to enhance the density of non-differential contacts. In other embodiments the distance 218 may be determined based on other criteria and/or methodology. In some embodiments, the distance 218 may be similar or identical to the distance 214. The distance 220 between the contacts 110 within a differential contact pair 202 may also be determined. The distance 220 may, according to some embodiments, be set and/or determined to be a relatively small distance to expose, for example, both paths leading from a differential contact pair 202 to a similar amount and/or type of interference (which assists in maintaining the integrity of the differential signal). In some embodiments the distance 220 may be substantially negligible, zero, and/or roughly equivalent to the gauge of the paths, traces, and/or wires. This may occur, for example, where the paths leading from the differential contact pair 202 are arranged as a twisted pair.

Turning now to FIG. 6, an exemplary routing layout for a docking connector 200 is shown. For ease of depiction only one row of differential contact pairs 202 is shown. Routing for other contacts 110 and/or other differential contact pairs 202 may, for example, be arranged on different layers and/or be routed in different directions than the routings shown, to maintain the any appropriate spacing 212, 214, 218, 222, 224. Each electrical contact 110 is shown connected to an electrical or other communications path or trace 116, which may, according to some embodiments, be similar to the paths 116 described in conjunction with FIG. 3 herein.

The paths 116 within a differential contact pair 202 may be maintained, in some embodiments, at a uniform spacing 222. The paths 116 of adjacent differential contact pairs 202 may similarly be maintained at a uniform spacing 224. In some embodiments, the spacing 222, 224 may be similar or identical to the center-to-center spacing 220, 212 determined for the arrangement of the electrical contacts 110. In other embodiments, the spacing 222, 224 may differ from the spacing 220, 212 determined and/or utilized in the arrangement of the electrical contacts 110. The length of the paths 116, as described herein, may, in some embodiments, be substantially the same.

Configurations relating to certain embodiments (such as that shown in FIG. 6) may, for example, be advantageous in that the docking connector 200 may approximate an optimal path for a differential signal, reducing the potential for interference with higher speed, higher frequency, and/or lower voltage transmissions. According to some embodiments, the docking connector 200 may permit docking devices to communicate at rates and integrities not previously possible for docked devices.

In some embodiments, the spacing 224 between paths 116 may be larger than the spacing 112a described with reference to FIG. 3 herein. For example, differential signals may require larger distances between themselves and contacts and/or traces carrying other signals, to maintain the integrity of the differential signal pair. In some embodiments, no signal may be routed closer to a differential signal pair than is desirable and/or practicable in order to maintain the integrity of the differential signal. The spacing 224 may be, for example, a minimum distance that may need to be maintained between a pair of differential signals and any other transmitted signal.

FIG. 7 is a block diagram of a system 700 according to some embodiments. The system 700 may include, for example, a portable device 710, a communications path 720, a processor 730, a memory 740, and a docking connector 750. The portable device 710 may be any type of network device including, for example, a PDA or a laptop computer. The portable device 710 may have a communications path 720 for sending and/or receiving various communications. In some embodiments, the communications path 720 may be for sending and/or receiving differential and/or other higher speed, higher frequency, and/or lower voltage signals in accordance with the method 150 described herein. The communication path 720 may be any type and/or combination of wired, wireless, intermittent and/or continuous communication paths, connections, wires, traces, devices, and/or ports known and/or available. The communications path 720 may, in some embodiments, also be connected to a docking connector 750. The docking connector 750 may, for example, be a docking connector 200 such as that described in conjunction with FIG. 5 herein.

The processor 730 may be any type of processor including, but not limited to, an Intel® PXA263 processor or a Mobile Intel® Pentium® 4 Processor coupled with an Intel® 852GME chipset. The memory 740 may be any type and/or configuration of data storage device known, available, and/or described herein. Also according to some embodiments, the processor 730 may create and/or process differential signals. The processor 730 may also send differential and/or other signals to other devices via communications path 720 and through the docking connector 750.

The several embodiments described herein are solely for the purpose of illustration. Persons skilled in the art will recognize from this description that other embodiments may be practiced with modifications and alterations limited only by the claims.

1. An apparatus, comprising:
a plurality of electrical contacts for a docking connector, wherein at least two electrical contacts are differential signal contacts arranged to allow for the transmission of a differential signal.

2. The apparatus of claim 1, further comprising:
a housing for the plurality of electrical contacts; and
at least one electrical connection to a printed circuit board.

3. The apparatus of claim 2, wherein the at least one electrical connection comprises:
electrical paths connecting each of the differential signal contacts to the printed circuit board, wherein the electrical paths have at least one of substantially the same length, substantially the same gauge, and substantially the same impedance.

4. The apparatus of claim 3, wherein the electrical paths are routed adjacent to each other and with a substantially uniform spacing, and wherein no other electrical paths are routed between the adjacent electrical paths.

5. The apparatus of claim 1, wherein all of the electrical contacts are arranged to allow for the transmission of differential signals.

6. The apparatus of claim 1, wherein at least one of the plurality of electrical contacts is a connector pin.

7. The apparatus of claim 1, wherein at least one of the plurality of electrical contacts is a connector pin receptor.

8. The apparatus of claim 1, wherein the differential signal contacts are a pair of adjacent electrical contacts having a spacing between the two contacts, the spacing determined based at least in part on the requirements for the transmission of the differential signal.

9. The apparatus of claim 1, wherein the differential signal contacts are spaced at a distance from the closest of the other of the plurality of contacts, the distance determined based at least in part on the requirements for the transmission of the differential signal.

10. A method, comprising:
receiving a differential signal at a docking connector; and
routing the differential signal to a printed circuit board.

11. The method of claim 10, further comprising:
transmitting a differential signal through the docking connector.

12. The method of claim 10, wherein the differential signal is received through at least two electrical contacts of the docking connector.

13. The method of claim 12, wherein the at least two electrical contacts are arranged on the docking connector in a manner determined at least in part based on the requirements for the transmission of the differential signal.

14. A method, comprising:
arranging at least one of a plurality of electrical contacts of a docking connector, wherein the arranging allows at least one differential signal to be transmitted through the connector.

15. The method of claim 14, further comprising:
determining, based at least in part based on the requirements for the transmission of the differential signal, a spacing to be maintained between a set of the plurality of electrical contacts.

16. The method of claim 15, wherein the determining is performed using an electrical simulation software program.

17. An apparatus, comprising:
a storage medium having stored thereon instructions that when executed by a machine result in the following:
determining an arrangement of at least one of a plurality of electrical contacts of a docking connector, wherein the arrangement allows at least one differential signal to be transmitted through the connector.

18. The apparatus of claim 17, wherein the determining the arrangement includes at least determining a spacing between the at least one of the plurality of electrical contacts and at least one of the other of the plurality of electrical contacts.

19. A system, comprising:
a portable electronic device, including:
a communication path to exchange information packets;
a memory for storing computer executable code;
a processor for executing the program code stored in memory; and
a docking connector having a plurality of electrical contacts, wherein at least two electrical contacts are differential signal contacts arranged to allow for the transmission of a differential signal.

20. The system of claim 19, further comprising:
a printed circuit board; and
at least one electrical connection for routing the differential signal between the printed circuit board and the docking connector.
